(19) United States
(12) Patent Application Publication
(10) Pub. No.: US 2015/0253841 A1
(43) Pub. Date: Sep. 10, 2015

(54) Storage Device Power Management

(71) Applicant: Microsoft Technology Licensing, LLC, Redmond, WA (US)

(72) Inventors: Changjiu Xian, Sammamish, WA (US); Bruce L. Worthington, Redmond, WA (US)

(21) Appl. No.: 14/721,821

(22) Filed: May 26, 2015

Related U.S. Application Data
(62) Division of application No. 13/102,890, filed on May 6, 2011, now abandoned.

(51) Int. Cl. G06F 1/32; G06F 3/06

(52) U.S. Cl. CPC G06F 1/3268; G06F 3/0676; G06F 3/061; G06F 3/0656; G06F 1/3293; G06F 2003/0692

(57) ABSTRACT

Techniques for storage device power management are described that enable coordinated buffer flushing and power management for storage devices. In various embodiments, a power manager can coordinate the flushing of pending or “dirty” data from multiple buffers of a computing device in order to reduce or eliminate interleaved (e.g., uncoordinated) data operations from the multiple buffers that can cause shortened disk idle periods. By so doing, the power manager can selectively manage power states for one or more power-managed storage devices to produce longer idle periods. For example, information regarding the status of multiple buffers can be used in conjunction with analysis of historical I/O patterns to determine appropriate times to spin down a disk or allow the disk to keep spinning. Additionally, user-presence information can be utilized to tune the aggressiveness of buffer coordination and state transitions for power-managed storage devices to improve performance.

### RELATED APPLICATIONS

This application claims priority under 35 U.S.C. Section 120 as a divisional application of U.S. patent application Ser. No. 13/102,890, filed May 6, 2011 and titled “Storage Device Power Management”, the entire disclosure of which is hereby incorporated by reference in its entirety.

### BACKGROUND

There are inherent energy and performance tradeoffs for disk power management algorithms that transition a disk (or other block storage device) to a low-power state when the disk is “idle.” In order for low power states to be effective, idle periods need to be sufficiently long so that the energy saved by spending time in the lower state exceeds the state-transition energy overheads. Meanwhile, latency involved in transitioning from a low-power state to an active state can delay I/Os (Inputs/Outputs) and impact user-perceived performance/responsiveness. Existing disk power management algorithms are inadequate to provide a good balance between performance and energy efficiency.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for storage device power management are described that enable coordinated buffer flushing and power management for storage devices. In various embodiments, a power manager can coordinate the flushing of pending or “dirty” data from multiple buffers of a computing device in order to reduce or eliminate interleaved (e.g., uncoordinated) data operations from the multiple buffers that can cause shortened disk idle periods. By so doing, the power manager can selectively manage power states for one or more power-managed storage devices to produce longer idle periods. For example, information regarding the status of multiple buffers can be used in conjunction with analysis of historical I/O patterns to determine appropriate times to spin down a disk or allow the disk to keep spinning Additionally, user-presence information can be utilized to tune the aggressiveness of buffer coordination and state transitions for power-managed storage devices to improve performance.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 is a flow diagram that describes steps of an example method in accordance with one or more embodiments.

FIG. 3 is a diagram showing an example buffer flushing scenario in accordance with one or more embodiments.

FIG. 4 is a flow diagram that describes steps of another example method in accordance with one or more embodiments.

FIG. 5 is a flow diagram that describes steps of another example method in accordance with one or more embodiments.

FIG. 6 is a flow diagram that describes steps of another example method in accordance with one or more embodiments.

FIG. 7 illustrates an example computing system that can be used to implement one or more embodiments.

### DETAILED DESCRIPTION

Overview

Techniques for storage device power management are described that enable coordinated buffer flushing and power management for storage devices. In various embodiments, a power manager can coordinate the flushing of pending or “dirty” data from multiple buffers of a computing device in order to reduce or eliminate interleaved (e.g., uncoordinated) data operations from the multiple buffers that can cause shortened disk idle periods. By so doing, the power manager can selectively manage power states for one or more power-managed storage devices to produce longer idle periods. For example, information regarding the status of multiple buffers can be used in conjunction with analysis of historical I/O patterns to determine appropriate times to spin down a disk or allow the disk to keep spinning Additionally, user-presence information can be utilized to tune the aggressiveness of buffer coordination and state transitions for power-managed storage devices to improve performance.

In the discussion that follows, a section titled “Operating Environment” is provided and describes one environment in which one or more embodiments can be employed. Following this, a section titled “Storage Device Power Management Techniques” describes example techniques and methods in accordance with one or more embodiments. This section includes several subsections that describe example implementation details regarding “Coordinated Buffer Flushing,” “Power State Management,” and “User Presence Detection.” Last, a section titled “Example System” describes example computing systems and devices that can be utilized to implement one or more embodiments.

### Operating Environment

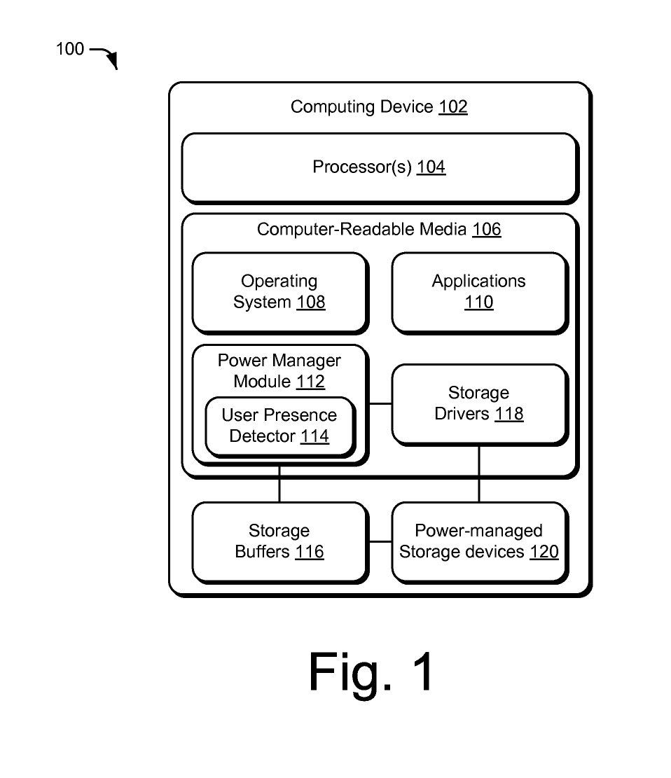

FIG. 1 illustrates an operating environment in accordance with one or more embodiments, generally at 100. Environment 100 includes a computing device 102 having one or more processors 104, one or more computer-readable media 106, an operating system 108, and one or more applications 110 that reside on the computer-readable media and that are executable by the processor(s). The processor(s) 104 may retrieve and execute computer-program instructions from applications 110 to provide a wide range of functionality to the computing device 102, including but not limited to office productivity, email, media management, printing, networking, web-browsing, and so forth. A variety of data and program files related to the applications 110 can also be included, examples of which include office documents, multimedia files, emails, data files, web pages, user profile and/or preference data, and so forth.

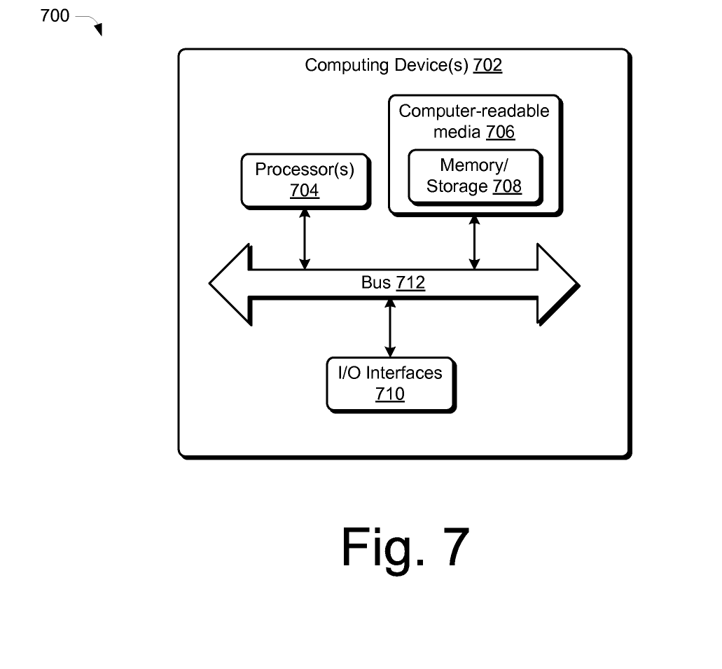

The computing device 102 can be embodied as any suitable computing system and/or device such as, by way of example and not limitation, a desktop computer, a portable computer, a tablet or slate computer, a handheld computer such as a personal digital assistant (PDA), a cell phone, a set-top box, and the like. One example of a computing system that can represent various systems and/or devices including the computing device 102 is shown and described below in FIG. 7.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 7.

The computing device 102 can also include a power manager module 112 that represents functionality operable to manage power and performance (e.g. responsiveness) for the computing device 102 in various ways. For example, the power manager module 112 can be configured to act as a controller that is operable to determine when to buffer (e.g., delay) data writes, when to flush outstanding dirty data from buffers, and when to spin down the disk(s) or other storage device of the computing device. The power manager module 112 can be implemented as a central manager and/or by way of multiple coordinated and distributed managers. The power manager module 112 can include or otherwise make use of a user presence detector 114 that represents functionality to determine whether a user is present (e.g., actively interacting with the computing device) and provide the information to the power manager module to be used for decisions regarding buffer flushing and power management.

The power manager module 112 is also depicted as being in communication with or otherwise interacting with multiple storage buffers 116. The power manager module 112 can establish buffer flushing schemes to coordinate flushing of data from the buffers in various ways. To facilitate a coordinated scheme, the storage buffers can be configured to communicate status notices to indicate to the power manager module 112 when the buffers are dirty (e.g., the buffers have pending data for a storage device) and when a flushing activity occurs. The power manager module 112 can also issue commands to direct the buffers to flush in accordance with a coordinated buffer flushing scheme.

The computing device 102 can also include one or more storage drivers 118 configured to provide interfaces and handle data transactions, and/or otherwise perform management for one or more power-managed storage devices 120. Although software based drivers are illustrated, hardware based drivers or controllers can also be employed. The storage drivers 118 can be configured to communicate power state status of corresponding power-managed storage devices 120 to the power manager module 112. For example, power state status for a disk storage device can be provided to the power manager module 112 by a corresponding storage driver when the disk spins-up or spins-down. The power manager module 112 can also issue requests to the power-managed storage devices 120 via the storage drivers to change power states in order to increase responsiveness or conserve power in different situations. The power-managed storage devices 120 can include any suitable storage device which can be configured to store data and which can be directed to operate in and transition between different power states. The power manager module 112 can therefore be configured to selectively set the power states of one or more power-managed storage devices 120 at different times and in response to the occurrence of various triggers. Examples of the power-managed storage devices 120 include but are not limited to hard (magnetic) drives, solid-state disks, optical drives, tape drives, and so forth.

Accordingly, in various embodiments, a power manager module 112 can be implemented to coordinate the flushing of dirty data from multiple buffers (e.g., file system caches or system data structure caches). This can occur in order to reduce or eliminate input/output operations (I/Os) that are interleaved from the various sources. The interleaving of I/Os creates shorter disk idle periods. In addition, the power manager module 112 can selectively manage power states for one or more power-managed storage devices 120 in a manner that takes into account the coordinated buffer flushing. This can create longer idle periods in which the power-managed storage devices 120 can be placed in a low power state. For instance, information regarding the buffer status can be used in conjunction with analysis of historical I/O patterns to determine when to spin down a disk versus allowing the disk to keep spinning in expectation that additional data operations are soon to occur. Additionally, user-presence information can be utilized to tune the aggressiveness of the buffer coordination and power state transition for the power-managed storage devices 120 to manage reliability and performance of the system. Further details regarding these and other aspects of storage device power management techniques can be found in the relation to the following figures.

Having described an example operating environment, consider now example techniques for storage device power management in accordance with one or more embodiments.

Storage Device Power Management Techniques

The following section provides a discussion of flow diagrams that describe techniques for storage device power management that can be implemented in accordance with one or more embodiments. In the course of describing the example methods, a number of subsections are provided that describe example implementation details for various aspects of storage device power management. The example methods depicted can be implemented in connection with any suitable hardware, software, firmware, or combination thereof. In at least some embodiments, the methods can be implemented by way of a suitability configured computing device, such as the example computing device 102 of FIG. 1 that includes or otherwise makes use of a power manager module 112.

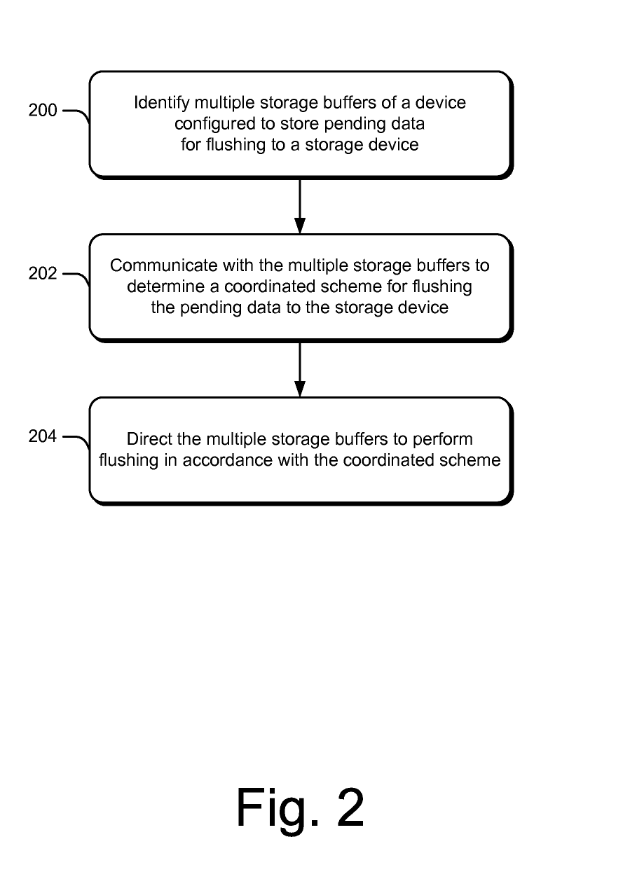

In particular, FIG. 2 depicts an example method in which flushing of multiple storage buffers is coordinated. Interleaved (e.g., uncoordinated) flushing of dirty buffers from multiple sources can shorten a disk's idle periods and prevent a disk from transitioning to a lower power state and/or decrease the amount of time the disk spends in a lower power state. Interleaved flushing can be avoided or reduced by coordinating the flush times of multiple buffers.

Step 200 identifies multiple storage buffers of a device configured to store pending data for flushing to a storage device. One or more storage buffers 116 of a computing device can be identified that are suitable for a coordinated flushing scheme in any suitable way. For instance, the power manager module 112 can interact with various storage drivers to detect corresponding storage buffers 116. Storage buffers 116 can also be configured to register with the power manager module 112 when they are created and/or initialized. Still further, the power manager module 112 can be configured to include a list of buffers that are involved in coordinated flushing. The power manager module 112 may enable a user to selectively designate buffers to coordinate through the list.

Step 202 communicates with the multiple storage buffers to determine a coordinated scheme for flushing the pending data to the storage device. For example, the power manager module 112 can identify buffers having pending data operations (e.g., “dirty buffers”) in any suitable way. For instance, the power manager module 112 can poll various storage buffers 116 periodically to determine when the buffers are dirty. In addition or alternatively, the power manager module 112 can be configured to obtain notifications sent from the various storage buffers 116 that include buffer status information to indicate whether or not the buffers are dirty. The power manager module 112 can then operate to coordinate the flushing of the storage buffers 116 that are identified. An appropriate coordinated flushing scheme can be selected based upon various characteristics of the buffers and/or associated data. The power manager module 112 may also enable a user to selectively choose between different coordinated schemes that are available.

Step 204 directs the multiple storage buffers to perform the flushing in accordance with a coordinated scheme. In particular, the power manager module 112 can examine buffer status information associated with the multiple buffers to generate, select, and/or apply a coordinated scheme for the multiple buffers. When applied, the coordinated scheme can implement one or more algorithms designed to control flushing of buffers in a coordinated manner. The buffer status information can include buffer parameters describing the amount of dirty data, delay tolerances indicating how long particular buffers are configured to delay before flushing data, timing information indicating the position of particular buffers in a flush cycle, designated buffer flush times, and various other buffer parameters. Thus, the power manager module 112 can make use of buffer status information to determine a coordinated scheme for flushing that optimizes the flushing based on various associated buffer parameters for the buffers that are coordinated.

The power manager module 112 can be further configured to implement various algorithms to coordinate buffer flushing. In general, the power manager module 112 provides the capability of communicating to and between buffers in order to cause buffer flushing in a coordinated manner. This can involve aligning the flush times for the buffers in accordance with one or more algorithms so that flushing occurs in a batched manner. Some example algorithms for coordinated dirty buffer flushing are described in the following section.

Coordinated Buffer Flushing

Various algorithms can be employed to coordinate dirty buffer flushing. The power manager module 112 can be configured to implement one or more algorithms individually and/or in different combinations of multiple algorithms that are used together. By way of example and not limitation, a few examples of suitable algorithms are provided just below.

In one coordinated buffer flushing approach, buffers can be flushed based upon a static or semi-static flush period. Individual buffers are notified periodically by the power manager module 112 to signal flushing. In this manner, the power manager module signals the buffers to flush in accordance with a designated flush period. The designated flush period can be set according to a configurable time interval that enables tuning of the system. In general, the flush period can be established to take into account delay tolerances for the coordinated buffers.

For instance, a static flush period can be set to a value equal to or lower than a global delay tolerance or to the minimum delay tolerance of a group of buffers. By so doing, coordinated buffers can be flushed periodically at least as frequently as the minimum tolerance across the coordinated buffers. This can ensure that each of the buffers is involved in the coordination and flushes in a batched manner rather than reaching its delay tolerance and flushing individually before coordinated flushing occurs. The flush period can also be configured as a semi-static period. A semi-static period can change dynamically as appropriate based on various workload or environmental characteristics (e.g., storage workload characteristics and the load level of I/O transactions and/or data operations). For example, if the storage workload is increasing, the buffer flushing period could be decreased to keep the bursts of activity from being excessive and thereby delaying large amounts of data. On the other hand, batched flushing can be set to occur at longer intervals when the storage workload is relatively light.

In a “first dirty” driven approach, buffer flushing can be driven based upon the timing of a first buffer among multiple coordinated buffers to become dirty. In this approach, the dirty buffer flushing requests sent out by the power manager module 112 are not strictly periodic. Rather, timing for the flushing requests are based on an interval of time (e.g., flush period) after the first pending data operation is obtained by one of the coordinated buffers. In other words, the timing is based upon when the first buffer becomes dirty. Since the timer does not begin until dirty data exists, this approach can still adhere to delay tolerance requirements while maximizing the time between dirty buffer flushes (i.e., increasing idle time). Compared with the static approach, and under the assumption that the data writes are not continual and/or closely spaced, the first dirty driven flushing can enable a device to stay in a low power state for a longer time between flushes. The power manager module 112 can be configured to implement first dirty driven flushing in the following manner.

After each coordinated flushing, the power manager module 112 can be configured to wait until one of the buffers gets dirty. When a buffer gets dirty, the buffer notifies the power manager module of this information. Upon receiving the first dirty notification from one of the buffers, the power manager starts a timer equal to a flush period that is associated with the buffer. When the timer expires, the power manager module sends requests to all the buffers to cause the buffers to flush their dirty data.

The flush period that drives the timer can be a global value that is set for each of the buffers. The global value can be set to satisfy the tolerance constraints for the coordinated buffers collectively. In addition or alternatively, an individual delay tolerance that is designated for the particular buffer can be employed. When individual delay tolerances are employed to establish the flush period, the power manager module 112 can be configured to check the timing in a rolling fashion after each buffer becomes dirty to ensure that the selected timing does not exceed any delay tolerances for the coordinated buffers. As each subsequent dirty notification arrives from a buffer, the power manager module 112 can examine the buffer delay tolerance for that subsequent buffer and determine whether the timing set by the first dirty notification flushing is too long for the delay tolerance. If so, the timer can be decreased as appropriate so that buffers are flushed together, now in accordance with the timing set by the subsequent buffer. Thus, in some embodiments timing for flushes can be adjusted dynamically in a rolling manner to account for individual delay tolerances.

In a disk “spin-up” driven approach, buffer flushing can be all or in part driven based upon the occurrence of a disk spin-up event. The disk spin-up event corresponds to transitioning of a power-managed storage device 120 from a low power state to a higher power state to service I/Os or other activity. The power manager module 112 can detect spin-up events and in response send requests to each buffer to cause the buffers to flush when a disk spin-up event occurs. The disk spin-up could be due to unbufferable I/Os, write-though I/Os, explicit flushes from applications, or other suitable reasons that cause the disk to spin-up. Since the disk spins-up to service such requests, the power manager module 112 can request buffers to flush their dirty data as a “piggy-back” activity. This approach makes efficient use of disk activity periods to perform coordinated flushing at times when the disk is already in an active power state. More generally, coordinated flushing can be configured to occur when the power manager module 112 detects a transition of a power-managed device from an inactive/low power state to an active/high power state.

The disk spin-up driven approach can be used in conjunction with either or both of the example approaches described previously. In conjunction with the periodic approach, the disk spin-up event can cause the power manager module to abort the current flush period (e.g., cancel the corresponding timer) and request buffers to flush their dirty data to coordinate with an intervening disk spin-up event (e.g., immediately) that occurs when the flush timer is running. Then, a new (full) flush period can be restarted for triggering the next flushing request. In conjunction with the first-dirty-driven approach, the disk spin-up event can also cause the power manager module 112 to abort the current flush timeout (if it exists) and request all buffers to flush their dirty data when the intervening disk spin-up/transition event occurs. Thereafter, the power manager module 112 can then wait for the next first-dirty notification before starting the next flush period and timer as described above.

Some other example approaches to coordinated flushing include but are not limited to flushing buffers more or less aggressively based upon power considerations such as battery life, charging status and so forth and/or flushing buffers when a predefined limit on dirty buffered I/O size or count is reached. The power based approach can be employed for example to flush more frequently when power considerations may be less critical and to delay flushing at other times to create longer idle periods. The predefined size or count limits can be used to set a limit on the burst of activity that will occur the next time the disk is spun-up or when buffer coordination is disabled. Random versus sequential I/O considerations could be included in determining an appropriate limit for size or count. For instance, larger limits can be employed when most I/Os are sequential as they generally take less time than random I/Os. This is particularly applicable on devices such as hard drives, optical drives, or tapes, but it should be noted that solid-state devices also have different random versus sequential performance characteristics that can be leveraged to tune coordinated buffer flushing.

It should be noted that buffers can also flush at other times outside of the coordinated scheme as deemed necessary by the buffers themselves. For example, a write-back buffer with dirty data may need to be flushed sooner when memory pressure is increasing, and thus available buffer space is becoming scarce. By default, buffers perform dirty data operations using their own algorithms. When interacting with a power manager module 112, the buffers may still be configured to perform independent I/O transactions due to the I/Os being unbufferable, a timer or tolerance setting within the buffer algorithm itself, or other buffer specific criteria to cause individual buffer flushing. In addition, buffers can be configured to respond to the power manager module 112 to flush in a coordinated manner with other buffers when possible. Further, even when a buffer decides to perform flushing independently, this creates a disk spin-up event the power manager module 112 can use to coordinate flushing with other buffers. As with other disk spin-up/transition events, the power manager module 112 can issue requests for buffer flushing to other coordinated buffers when one buffer initiates a flush independently. Thus, even if buffers act on their own, the flushing times can still be coordinated between multiple buffers.

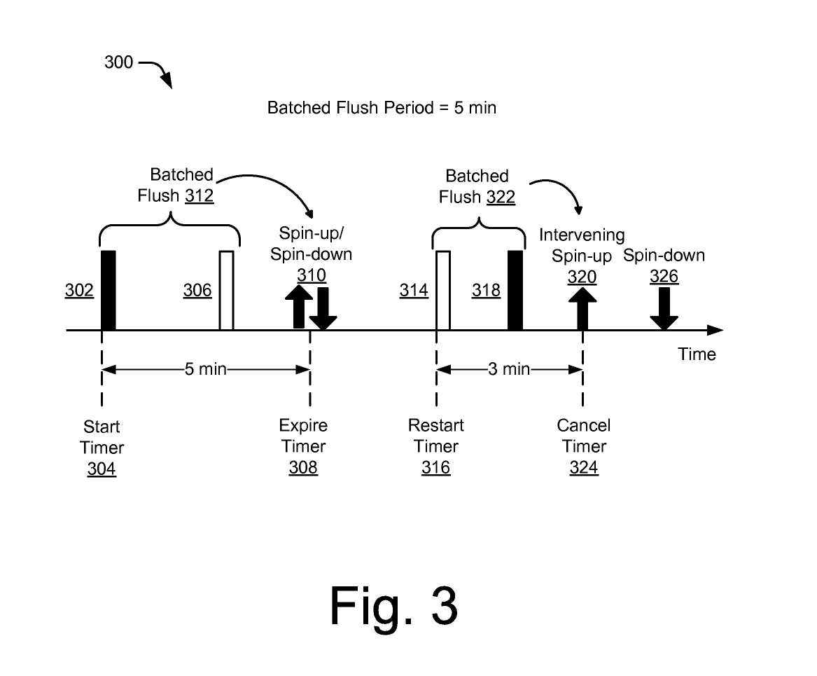

To further illustrate, consider now an example buffer flushing scenario that is depicted in FIG. 3, generally at 300. In the example scenario, an example timeline for coordinated buffer flushing is depicted. The example depicts dirty buffer events represented by respective rectangles for two coordinated buffers. Further, the flush period in this example is set to a global value of five minutes.

At 302, a first dirty buffer event occurs for the first buffer as represented by the black rectangle. This causes a timer for the five minute flush period to start at 304. Sometime during the flush period a dirty buffer event occurs at 306 for the second buffer as represented by the white rectangle. Since the timer running to coordinate flushing has not timed out, the two buffers have not yet flushed their data at this point.

Now, at 308 the timer expires after the five minute flush period. In response, the power manager module 112 can cause a spin-up/spin-down event at 310 that enables a batched flush 312 to occur for the two coordinated buffers. There may or may not be a delay (e.g., via a second timer) between finishing the flush I/Os and the spin-down event. Since there was no intervening I/O triggering the flush, there may be no reason to believe that an intervening I/O will occur soon after the flush completes. Therefore, spinning down the disk immediately could be done in some implementations.

In the foregoing case, the first dirty driven approach to coordinated buffer flushing is represented using a global flush period. Accordingly, after the flush occurs, the timer does not restart until the next dirty buffer. If instead a static flush period approach was employed, the timer could reset to five minutes right after the flushing is complete. In the present example, though, the power manager module 112 does not restart the timer and awaits the next dirty event. Note that in the interim the disk and/or other power-managed device(s) 120 corresponding to the coordinated buffers can be transitioned into a lower power state to conserve power.

At 314, the next dirty buffer event occurs as represented by the white rectangle, this time for the second buffer. This is again considered the “first” dirty event because it is the first event of the particular batched flushing period. Accordingly, the timer for the five minute flush period is restarted at 316. At some time within the flush period a dirty buffer event occurs at 318 for the first buffer as represented by the black rectangle. Again, since the timer is running to coordinate flushing, the two buffers can delay flushing.

Now, at 320 an intervening spin-up occurs before the running of the five minute flush period. The intervening spin-up is illustrated as occurring at three minutes into the flush period. The intervening spin-up could be initiated by an external source, in response to unbufferable I/O, independently by one of the coordinated buffers, when user presence is detected, and/or for other reasons that cause the disk to spin-up before the flush period expires. As the disk is already spun-up, the power manager module 112 can take advantage of this by causing the batched flush 322 to occur for the coordinated buffers in conjunction with the intervening event. The power manager module 112 also cancels the timer at 324 since the flushing that would have occurred when the timer expired was performed early due to the intervening event. The disk will remain spun-up for some time to handle the intervening I/O transactions and data operations. Sometime after the transactions are complete, a spin-down occurs at 326 for the associated disk and/or other power-managed devices. The spin-down could occur immediately after the flush I/O transactions complete. Alternately, a third timer could be used to delay the spin-down for some period of time, under the expectation that further intervening I/O activity is likely to occur before that third timer completes, thereby saving the additional spin-up and spin-down that would result from that activity if the spin-down had occurred immediately after the flush transactions had completed.

Thus, the example scenario of FIG. 3 illustrates using both the first dirty driven and the disk spin-up driven approaches to coordinated buffer flushing and shows how multiple flushing approaches such as these can be used in combination. As mentioned, coordinated dirty buffer flushing can be used to make decisions regarding power management for power-managed devices, details of which are provided in the following section.

Power State Management

Power states for power-managed storage devices can be managed to conserve power and/or boost responsiveness for a computing device in different scenarios. A variety of techniques can be used to implement power state management for devices. Algorithms used for power state management can be informed by coordinated buffer flushing and/or historical patterns of I/O transactions to understand and anticipate when to transition between different states. This section includes some illustrative examples of algorithms and techniques that can be employed for power state management of various storage devices.

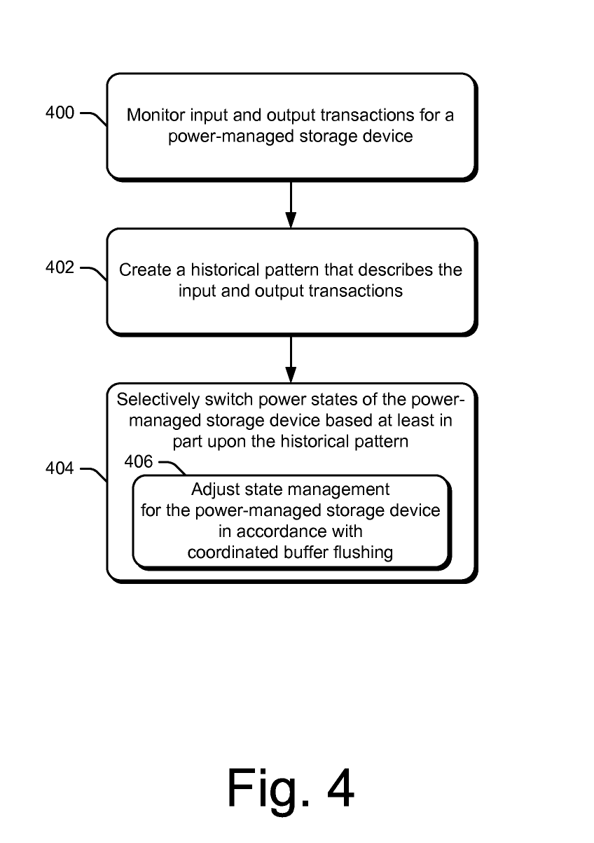

In particular, FIG. 4 depicts an example method in which power states for a power-managed storage device are selectively switched based on I/O patterns. Step 400 monitors input and output transactions for a power-managed storage device. For example, the power manager module 112 can communicate with storage drivers 118 to monitor transactions that occur for corresponding power-managed storage devices. This can occur in various ways, such as by polling the drivers, receiving notifications from the drivers describing different transactions, obtaining transaction log data, and so forth. The power manager module 112 can therefore collect, manage, and store data that describes input and output transactions for one or more power-managed storage devices.

Step 402 creates a historical pattern that describes the input and output transactions. For instance, the power manager module 112 can analyze the data that is collected through the monitoring of step 400 to understand a pattern of the I/O transactions. Based on this analysis, the power manager module 112 can generate an I/O pattern that represents an abstracted version of the complete I/O history. The I/O pattern can be used to determine expected timing of transactions and manage the disk accordingly.

In particular, step 404 selectively switches powers states of the power-managed storage device based at least in part upon the historical pattern. Thus, when the I/O pattern indicates that I/O or other activities are unlikely in the near future for a device, the power manager module 112 can interact with a storage driver 118 to place the device into a low power state (e.g., spin-down). On the other hand, if some quantity of activity is expected based on the I/O pattern, power manager module 112 can operate to maintain the device in an active power state (e.g., spin-up) to service the activity. Some details regarding techniques for managing disk power state transitions can be found in the discussion that follows.

Optionally, step 406 adjusts the state management for the power-managed storage device in accordance with coordinated buffer flushing. As noted, one goal of coordinated buffer flushing is to increase disk idle periods. To take advantage of coordinated buffer flushing, the power manager module 112 can cause devices to enter low power states during these idle periods. Typically, these periods occur after flushing has taken place. Thus, power manager module 112 can be configured to spin-down the disk immediately or aggressively after coordinated flushing occurs. Likewise, the power manager module 112 can wait to spin-down a device when another coordinated flush is expected soon because spinning down for a short time would be inefficient. This is because the transition between states has power/overhead costs that cannot be recovered unless the time spent in the low power state is sufficiently long. The time to recover the transition cost is referred to as the break-even time.

As noted, the power manager module 112 can operate to transition devices to lower power states based on historical I/O patterns and/or using information from dirty buffer coordination. The rationale is that the disk can be spun down when the I/O pattern suggests that the next intervening I/O is unlikely to occur within the near future. The definition of “near future” may be based on the break-even time and/or the frequency of performance penalty (due to spin-up) that is acceptable. Otherwise, the disk can stay spun up to avoid unwarranted transition overhead or to prevent excessive delays for on-demand I/Os. For example, if intervening I/Os tend to occur in bursts, then spinning down a drive that was spun up as the result of an intervening I/O can be delayed until it can be determined that the burst is likely completed. Additionally, if the time of the next coordinated flushing is known in advance or can be approximated, this information can also be taken into account for state transition decisions

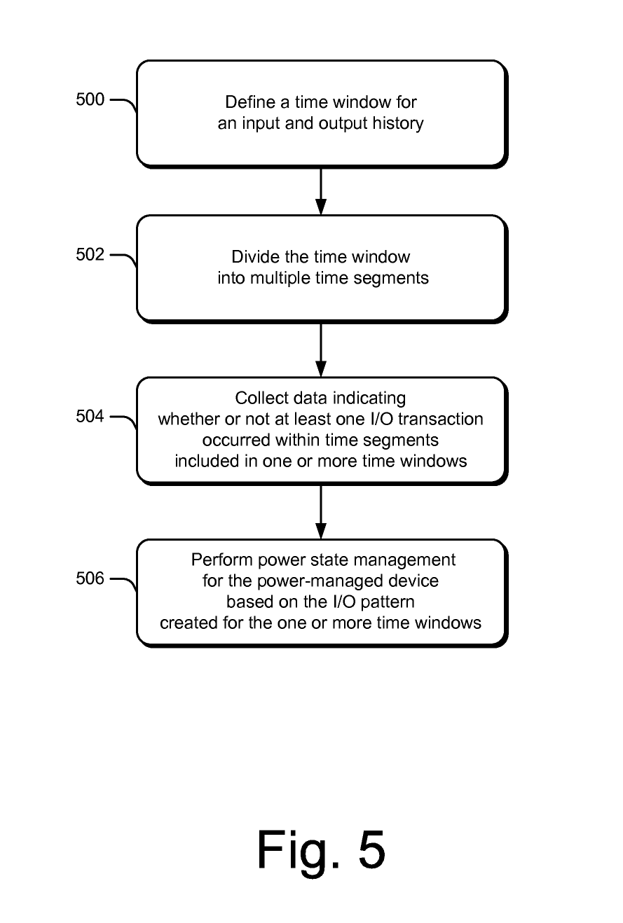

One example approach to transitioning a device to a low power state based on I/O patterns is described in relation to FIG. 5. In particular, FIG. 5 depicts an example of a low-cost approach (in terms of CPU and memory utilization) to creating a historical I/O pattern that is suitable for power state management. Naturally, a variety of other types of I/O patterns, both simple and complex, can be generated and employed for device power management.

At step 500 a time window is defined for an input and output history. The time window can be defined as a configurable length of time upon which collected data regarding I/O transactions can be analyzed. For example, the time window can be set to a defined length of X seconds. The particular value of X can be configured to tune the system. The complete input and output history can be made up of multiple time windows and a record of I/O transactions that occur within the time windows. Within any particular time window, I/O transactions may or may not occur. In one approach, the time windows correspond to consecutive periods of time that are adjacent to one another. In addition or alternatively, the time windows can be configured to correspond to overlapping periods of time that create a sliding time window.

At step 502 the time window is divided into multiple time segments. In particular, each time window can be divided into multiple equal or non-equal segments that are referred to herein as buckets. For instance, time windows can be divided into Y buckets, where Y designates the number of buckets. The buckets correspond to defined intervals within a time window for which I/O transactions are monitored, recorded, and/or analyzed. For example, assume that the time window X is set to 60 seconds. If the value of Y is set to 4, this creates 4 buckets in each time window. The buckets can be equal sized buckets of 15 seconds each. More generally, Y buckets can be formed for each window and that are each equal to X/Y seconds. As mentioned, buckets of unequal size could also be employed in some scenarios.

At step 504 data is collected that indicates whether or not at least one I/O transaction occurred within time segments included in one or more time windows. Here, a determination can be made regarding whether at least one I/O occurred within each bucket in a particular time window. The determination can be repeated for each bucket in each time window. In effect, data is collected and associated with the buckets defined for the process. The data collection can be an ongoing process that occurs on a rolling basis, such as to populate a history log, array, or database. In one approach, the data collection can involve associating a binary or Boolean value (e.g., 1 or 0, TRUE or FALSE, Yes or No) with each bucket.

In one embodiment, data that is collected indicates TRUE for buckets in which at least one I/O transaction occurred and indicates FALSE for buckets in which no I/O transactions occurred. In addition or alternatively, further data can be collected including but not limited to the number of transaction in each bucket, timestamps for transactions, types of transactions, source of the transactions, and so forth.

In the foregoing example of 4 buckets, an example I/O pattern that could be generated and collected for three time windows using binary or Boolean values can be represented as in Table 1 that follows:

TABLE 1
Example I/O Pattern

| | Bucket 4 | Bucket 3 | Bucket 2 | Bucket 1 |
|---|---|---|---|---|
| Time Window 1 | FALSE | FALSE | FALSE | FALSE |
| Time Window 2 | TRUE | FALSE | FALSE | FALSE |
| Time Window 3 | FALSE | TRUE | FALSE | FALSE |

In the above table, the oldest bucket for each time window appears in the leftmost column. The example pattern can correspond to adjacent or sliding time windows. Data may be collected directly for the defined time windows. In the case of a sliding time window, the window can be advanced by adding a new bucket and discarding the oldest bucket. This can occur by advancing the window every X/Y seconds. This creates a circular array type of data structure for the collected data. A number of windows to use for the analysis can also be designated. For instance, 3 windows can be used as in the example of Table 1. In this case, the oldest window can be discarded and a new window added on a rolling basis. Thus, the amount of memory and power to store and process the collected data can be kept relatively small.

In another approach, raw data for the buckets can be collected (e.g., logged) at the corresponding time interval. Then selected windows can be derived for the purpose of processing the raw bucket data. This can occur without arranging the data into particular windows at the time the data is collected. This approach provides flexibility to conduct multiple different kinds of analysis to process the raw data using various configurations for the windows.

Step 506 performs power state management for a power-managed device based on the I/O patterns created for the one or more time windows. For example, an I/O pattern as in example Table 1 can be used to make decisions regarding whether to transition a power-managed storage device to a lower power state, keep the current state, and/or boost power to a higher power state. The power manager module 112 can be configured to consider the I/O pattern for multiple time windows individually or collectively. The power manager module 112 can be configured in various ways to manage power based on the I/O pattern.

Generally speaking, when the I/O pattern indicates that activity is frequent and/or increasing, the power manager module 112 can respond by acting less aggressively to save power. In this case, the power manager 112 can keep power-managed devices in relatively higher power state to boost responsiveness. Thus, for example, disk spin-downs can be set to occur less frequently.

On the other hand, when the I/O pattern indicates that activity is infrequent and/or decreasing, the power manager module 112 can respond by acting more aggressively to save power. In this case, the power manager 112 can manage power-managed devices to set lower power states to take advantage of idle periods. Thus, for example, disk spin-downs can be set to occur more frequently.

Different I/O patterns, individually or in combination, can be set to trigger powers state transitions. For example, a single pattern such as FALSE, FALSE, FALSE, FALSE could trigger more aggressive power state transitions to save power due to low activity. Likewise, a single pattern such as TRUE, TRUE, TRUE, FALSE could trigger power state transitions to increase responsiveness due to increasing I/Os. The analysis can also consider the total number of FALSE and TRUE values that occur within one or more time windows and make power state management decisions accordingly. A single TRUE in one window may be insufficient to trigger less aggressive power conservation. However, one TRUE in multiple windows can be set as a trigger. Thus, a variety of triggers based on an I/O pattern can be defined and used to implement power state management.

User Presence Detection

User presence information can be employed to tune coordinated buffer flushing algorithms and the power state transition algorithms. When the user is determined to be present, the algorithms for entering low-power states can be tuned to be more conservative to favor performance/responsiveness and even reliability. When the user is determined to be absent, the algorithms can be tuned to more aggressively to save power.

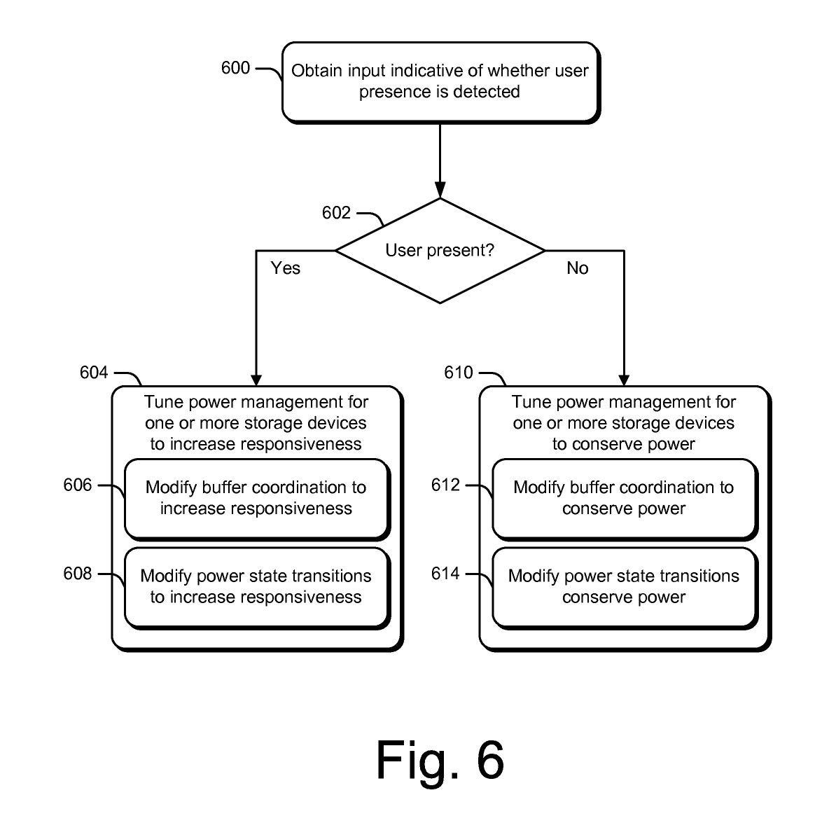

In particular, FIG. 6 depicts an example method in which user presence can be employed to selectively manage power states for a storage device and/or buffer flushing. Step 600 obtains input indicative of whether user presence is detected and Step 602 determines whether a user is present according to the input.

If the user is present, step 604 tunes power management for one or more storage devices to increase responsiveness. This can include modifying buffer coordination to increase responsiveness at step 606 and/or modifying power state transitions to increase responsiveness at step 608.

If the user is not present, step 610 tunes power management for one or more storage devices to conserve power. This can include modifying buffer coordination to conserve power at step 612 and/or modifying power state transitions to conserve power at step 614.

In this manner, a power manager module 112 can operate to detect user presence and selectively manage buffer coordination and power state transitions according to whether a user is present or absent. One way this can occur is through a user presence detector 114 provided by a power manager module 112. The user presence detector 114 can operate to monitor and detect various different kinds of input associated with different components that are indicative of user activities.

For example, various user inputs can be correlated to the start of particular user operations or activities (e.g., tasks, commands, or transactions) executed by the system. For instance, user inputs are frequently performed to start corresponding activities such as to launch an application, open a dialog, access the Internet, switch between programs, and so forth. At least some of these activities can be enhanced by boosting power to cause a corresponding increase in the user-perceived responsiveness of the system. Therefore, various triggering inputs and/or activities obtained from any suitable input device (e.g., hardware device inputs) can be detected to cause power management operations for a device. This includes boosting responsiveness when the user is present and implementing power state transitions to lower states when the user is not present. Triggers can also be generated via software that simulates device inputs. Further, inputs can include both locally and remotely generated inputs.

Software generated inputs can include, but are not limited to, remote/terminal user commands sent from a remote locations to the computing device, and other software-injected inputs. Hardware device inputs obtained from various input devices can include, but are not limited to, mouse clicks, touchpad/trackball inputs and related button inputs, mouse scrolling or movement events, touch screen and/or stylus inputs, game controller or other controllers associated with particular applications, keyboard keystrokes or combinations of keystrokes, device function buttons on a computing device chassis or a peripheral (e.g., printer, scanner, monitor), microphone/voice commands, camera-based input including facial recognition, facial expressions, or gestures, fingerprint and/or other biometric input, and/or any other suitable input initiated by a user to cause operations by a computing device. If available, direct detection of human presence can also be made through dedicated sensors such as infrared, temperature, and/or motion sensors, and the like. Detection of human presence can also be based on detection of wearable devices such as Bluetooth devices or other wireless devices that can be “worn” or carried (e.g., headsets, phones, and cameras).

Thus, the user presence detector 114 can be implemented to monitor user activity and detect various inputs and/or combination of inputs that trigger power management. Various adjustments can be made to modify techniques for buffer coordination and power state management based upon whether a user is determined to be present or not.

For example, when a user is present, buffer coordination can be turned off or adjusted to increase responsiveness and prevent data loss that could occur from long buffer periods and/or unexpected system failures. In particular, the power manager module 112 can disable buffer coordination and request buffers to perform their normal (uncoordinated) flushing when a user is present. In addition or alternatively, a shorter flush period can be used for the static approach and/or a shorter timeout can be used in the first dirty driven approach when user presence is detected. Further, the data size limit or I/O count limit set for buffer coordination can be reduced to cause flushes to occur more frequently. After a set period of time and/or when user absence is no longer detected, buffer coordination can be turned back on and/or adjusted to “normal” conditions.

With respect to power state management and transition algorithms, adjustments can also be made when user presence is detected. For example, after a user is present for a designated amount of time, one or more power managed devices can be automatically spun-up in anticipation of a high volume of I/O transactions due to user activity. This can improve responsiveness by avoiding spin-up delays that may be user-perceivable.

Another way to adjust power state management in response to user presence is to be more conservative about spinning down. This can be accomplished by using more conservative I/O pattern triggers. For example, in the previously discussed 4 bucket example, spin-down can be set to occur only when all of the buckets are set to FALSE based on having no activity within the corresponding time segment. In addition or alternatively, a longer sliding time period for the sliding window can be employed. In this case, for example, a spin down may be set to occur when there are no (or very few) I/Os within a five-minute time frame. Another way to implement more conservative spin-downs is to set or adjust a limit on the frequency of spin-downs. In this case, the spin-down limit can be adjusted when a user is present so that spin-downs occur less frequently (e.g., at most N per hour) to limit the potential for user-perceivable delays.

Any of the foregoing example adjustments that occur when a user is present can be undone and/or adjusted in the opposite direction when the user is absent to be more aggressive with buffer coordination and/or power state management for power-managed devices. Having described some example techniques for storage device power management, consider now an example system that can be used to implement aspects of the described techniques in accordance with one or more embodiments.

### Example System

FIG. 7 illustrates an example system generally at 700 that includes an example computing device 702 that is representative of one or more such computing systems and/or devices that may implement the various embodiments described above. The computing device 702 may be, for example, a server of a service provider, a device associated with the computing device 102 (e.g., a client device), an on-chip system, and/or any other suitable computing device or computing system.

The example computing device 702 includes one or more processors 704 or processing units, one or more computer-readable media 706 which may include one or more memory and/or storage components 708, one or more input/output (I/O) interfaces 710 for input/output (I/O) devices, and a bus 712 that allows the various components and devices to communicate one to another. Computer-readable media 706 and/or one or more I/O devices may be included as part of, or alternatively may be coupled to, the computing device 702. The bus 712 represents one or more of several types of bus structures, including a memory bus or memory controller, a peripheral bus, an accelerated graphics port, and a processor or local bus using any of a variety of bus architectures. The bus 712 may include wired and/or wireless buses.

The one or more processors 704 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 708 represents memory/storage capacity associated with one or more computer-readable media. The memory/storage component 708 may include volatile media (such as random access memory (RAM)) and/or nonvolatile media (such as read only memory (ROM), Flash memory, optical disks, magnetic disks, and so forth). The memory/storage component 708 may include fixed media (e.g., RAM, ROM, a fixed hard drive, etc.) as well as removable media (e.g., a Flash memory drive, a removable hard drive, an optical disk, and so forth).

Input/output interface(s) 710 allow a user to enter commands and information to computing device 702, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the power manager module 112, operating system 108, applications 110, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 702 may be configured to implement particular instructions and/or functions corresponding to the software and/or hardware modules implemented on computer-readable media. The instructions and/or functions may be executable/operable by one or more articles of manufacture (for example, one or more computing devices 702 and/or processors 704) to implement techniques for storage device power management, as well as other techniques. Such techniques include, but are not limited to, the example procedures described herein. Thus, computer-readable media may be configured to store or otherwise provide instructions that, when executed by one or more devices described herein, cause various techniques for storage device power management.

### CONCLUSION

Techniques for storage device power management have been described. The described techniques enable coordinated buffer flushing and power state management for storage devices. Flushing for multiple buffers of a computing device can be coordinated in order to reduce or eliminate interleaved storage accesses that shorten idle periods. By so doing, power states for one or more power-managed storage devices can be managed to improve energy efficiency. User-presence information can also be utilized to tune the aggressiveness of buffer coordination and state transitions for power-managed storage devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method comprising:
detecting when a first buffer among coordinated storage buffers has pending data to flush to a storage device;
starting a timer for a flush period associated with the first buffer; and
notifying the coordinated storage buffers to flush data to the storage device when the timer expires.

2. The computer implemented method of claim 1, further comprising polling the coordinated storage buffers periodically to determine when the coordinated storage buffers have pending data to flush to a storage device.

3. The computer implemented method of claim 1, further comprising:
detecting an intervening event before the timer expires; and
in response to the intervening event causing the coordinated storage buffers to flush data to the storage device and canceling the timer.

4. The computer implemented method of claim 3, the intervening event comprising one of:
a disk spin-up event for the storage device;
input activity at the storage device; or
output activity at the storage device.

5. The computer implemented method of claim 1, further comprising:
detecting, before the timer expires, when a second buffer among the coordinated storage buffers has pending data to flush to the storage device;
checking a delay tolerance associated with the second buffer to determine whether remaining time in the flush period exceeds the delay tolerance; and
modifying the flush period based on the delay tolerance associated with the second buffer when the remaining time in the flush period exceeds the delay tolerance.

6. The computer implemented method of claim 1, further comprising causing the storage device to transition to a low power state after the coordinated storage buffers flush data to the storage device to conserve power in a subsequent idle period.

7. The computer implemented method of claim 1, further comprising:
selectively setting the flush period based on user presence to increase responsiveness when presence of a user is detected and to conserve power when presence of a user is not detected.

8. One or more computer-readable storage media storing instructions that, when executed via a computing device, implement an power manager module configured to perform acts comprising:
monitoring input and output transactions for a power-managed storage device;
creating a historical pattern that describes frequency of the input and output transactions;
switching power states of the power-managed storage device based at least in part upon the frequency of input and output transactions; and
adjusting the switching of the power states for the power-managed storage device in accordance with coordinated buffer flushing of multiple storage buffers to:
transition to a low power state to conserve power during idle time that follows coordinated flushing of the multiple storage buffers that occurs in response to a timer event; and
delay the transition to the low power state when coordinated buffer flushing occurs in response to an event for which additional input and output transactions are expected to occur.

9. One or more computer-readable storage media of claim 8, wherein switching power states comprises transitioning the power-managed storage device to a low power state to conserve power when the historical pattern indicates infrequent input and output transactions.

10. One or more computer-readable storage media of claim 8, wherein switching power states comprises transitioning the power-managed storage device to a high power state to boost responsiveness when the historical pattern indicates frequent input and output transactions.

11. One or more computer-readable storage media of claim 8, wherein creating the historical pattern comprises:
defining a time window for examining the input and output transactions;
dividing the time window into multiple time segments; and
ascertaining whether or not at least one input and output transaction occurred within time segments included in one or more time windows to create a pattern that describes frequency of the input and output transactions.

12. One or more computer-readable storage media of claim 8, wherein the power manager module is further configured to perform acts comprising:
determining when a user is present by monitoring one or more inputs indicative of user activities and when the user is present causing transitions to the low power state based on the historical pattern to occur more conservatively; and
applying a coordinated scheme to direct the multiple storage buffers to flush data to the power-managed storage device in a coordinated manner.

13. A system comprising:
one or more processors; and
one or more computer-readable storage media including instructions stored thereon that are executable by the one or more processors to perform operations comprising:
detecting when a first buffer among coordinated storage buffers has pending data to flush to a storage device;
starting a timer for a flush period associated with the first buffer; and
notifying the coordinated storage buffers to flush data to the storage device when the timer expires.

14. The system of claim 13, the operations further comprising polling the coordinated storage buffers periodically to determine when the coordinated storage buffers have pending data to flush to a storage device.

15. The system of claim 13, the operations further comprising:
detecting an intervening event before the timer expires; and
in response to the intervening event causing the coordinated storage buffers to flush data to the storage device and canceling the timer.

16. The system of claim 15, the intervening event comprising one of:
a disk spin-up event for the storage device;
input activity at the storage device; or
output activity at the storage device.

17. The system of claim 13, the operations further comprising:
detecting, before the timer expires, when a second buffer among the coordinated storage buffers has pending data to flush to the storage device;
checking a delay tolerance associated with the second buffer to determine whether remaining time in the flush period exceeds the delay tolerance; and
modifying the flush period based on the delay tolerance associated with the second buffer when the remaining time in the flush period exceeds the delay tolerance.

18. The system of claim 13, the operations further comprising causing the storage device to transition to a low power state after the coordinated storage buffers flush data to the storage device to conserve power in a subsequent idle period.

19. The system of claim 13, the operations further comprising selectively setting the flush period based on user presence to increase responsiveness when presence of a user is detected and to conserve power when presence of a user is not detected.

20. The system of claim 13, wherein a period associated with the timer is configured as a semi-static period that dynamically changes based on a storage workload of the storage device.
